(19) United States
(12) Patent Application Publication
(10) Pub. No.: US 2025/0389397 A1
(43) Pub. Date: Dec. 25, 2025

(54) Modular Illumination Device

(71) Applicant: Jet Optoelectronics Co., Ltd., Taipei City (TW)

(72) Inventors: Ke-Yu Tsai, New Taipei City (TW); Sheng-Yueh Lin, Taipei City (TW); Yu-Feng Chen Lee, Taipei City (TW); Chun-Yuan Hsu, Taipei City (TW)

(21) Appl. No.: 19/064,866

(22) Filed: Feb. 27, 2025

(30) Foreign Application Priority Data
Jun. 25, 2024 (TW) 113123595

(51) Int. Cl. F21S 2/00; F21V 17/10; F21V 23/04; F21V 33/00

(52) U.S. Cl. CPC F21S 2/005; F21V 17/105; F21V 23/04; F21V 33/0056

(57) ABSTRACT

A modular illumination device includes a light-emitting module that includes a body unit, a first power supply, a plurality of first light illuminators connected to first power supply and a first switch between the first power supply and the first light illuminators. The body unit includes a main frame portion, a first light-transmitting portion disposed on one side of the main frame portion, and a second light-transmitting portion disposed on another side of the main frame portion. The plurality of first light emitters are disposed to respectively correspond to the first light-transmitting portion and the second light-transmitting portion, The first switch is configured to toggle at least one of the plurality of first light illuminators to project a light beam toward the corresponding first light-transmitting portion or the corresponding second light-transmitting portion. Thereby, the modular illumination device may improve the convenience of illumination.

### CROSS-REFERENCE TO RELATED APPLICATION

This application claims priority from Taiwan Patent Application No. 113123595, filed on Jun. 25, 2024, in the Taiwan Intellectual Property Office, the content of which is hereby incorporated by reference in its entirety for all purposes.

### BACKGROUND OF THE INVENTION

### 1. Field of the Invention

The present disclosure relates to a modular illumination device, and more particularly to a detachable modular illumination device with multiple illumination modes.

### 2. Description of the Related Art

Although most vehicles are equipped with factory-installed lights in the cargo trunk, the illumination capability of these lights is often insufficient in darker environments, such as in the basements or at night.

Moreover, the trunk light in most vehicles is fixed in a single position, rendering it non-adjustable. Consequently, when the light is obstructed by cargo, it becomes more difficult to locate smaller items within the trunk. Additionally, the fixed design prevents the light from being relocated for other purposes or applications during outdoor activities.

### SUMMARY OF THE INVENTION

In response to the above-referenced technical inadequacies, the present disclosure provides a modular illumination device.

The modular illumination device includes a light-emitting module that includes a body unit, a first power supply, a plurality of first light illuminators and a first switch. The body unit has a main frame portion, a first light-transmitting portion and a second light-transmitting portion, the first light-transmitting portion is disposed on one side of the main frame portion, and the second light-transmitting portion is disposed on another side of the main frame portion. the first power supply being arranged in the main frame portion, the plurality of first light emitters being connected to the first power supply, the plurality of first light emitters being disposed on the main frame portion and corresponding to the first light-transmitting portion and the second light-transmitting portion, The first switch is disposed on the main frame portion, the first switch is connected to the first power supply and the plurality of first light illuminators, and the first switch is configured to toggle at least one of the plurality of first light illuminators to project a light beam toward the corresponding first light-transmitting portion or the corresponding second light-transmitting portion.

Preferably, the first switch may be configured to toggle the at least one light-emitting module to change from an initial state to a first light-emitting state, a second light-emitting state or a third light-emitting state. When the at least one light-emitting module is in the first light-emitting state, at least one of the first light illuminators may project the light beam toward the corresponding first light-transmitting portion. When the at least one light-emitting module is in the second light-emitting state, at least one of the first light illuminators may project the light beam toward the corresponding second light-transmitting portion. When the at least one light emitting module is in the third light emitting state, the plurality of first light emitters may project a plurality of light beams toward the corresponding first light-transmitting portion and the second light-transmitting portion.

Preferably, the modular illumination device may further include multiple ones of the light-emitting module, one end the main frame portion of each of the light-emitting modules may include a first connecting portion, another end the main frame portion of each of the light-emitting modules may include a second connecting portion, one of the light-emitting modules may be detachably connected to the second connecting portion of another one of the light-emitting modules through the first connecting portion, so as to be connected to the another one of the light-emitting modules.

Preferably, an end surface of the one end of the main frame portion may protrude outward to form a plurality of hook structures to form the first connecting portion, and an end surface of the another end of the main frame portion may be recessed inward to form a plurality of groove structures to form the second connecting portion. The modular illumination device may further comprise at least one covering module detachably connected to the main frame portion of one of the light-emitting modules, and the at least one covering module may be configured to cover the first connecting portion or the second connecting portion and to be attached on an object.

Preferably, the main unit may further include a magnetic attachment portion located on the main frame portion, and the magnetic attachment portion may be configured to magnetically coupled to an object. The at least one light emitting module may further include an indicator connected to the first power supply, and the indicator may be configured to display a power status of the first power supply.

Preferably, the modular illumination device may further include a power module, which may include a main unit, a second power supply and a second switch. The second power supply may be disposed in the main unit. The second switch may be disposed in the main unit. When the main unit is connected to the body unit, the second power supply may be connected to the first power supply. The second switch may be configured to toggle at least one of the first light illuminators to project a light beam toward the corresponding first light-transmitting portion or the corresponding second light-transmitting portion.

Preferably, the modular illumination device may further include a light projector, which may include a head unit and a plurality of second light illuminators. The plurality of second light illuminators may be disposed in the head unit. When the cover unit is connected to the body unit, the plurality of second light illuminators may be connected to the first power supply. The first switch may be configured to toggle the plurality of second light illuminators to project light beams.

Preferably, the modular illumination device may further include a bracket module detachably connected to the body unit, and the bracket module may be configured to be detachably connected to an object.

Preferably, the modular illumination device may further include a hook module detachably connected to the body unit, and the hook module may be configured to be detachably connected to an object.

Preferably, the modular illumination device may further include a smart speaker, which includes a speaker body, a third light illuminator and a base. The speaker body is detachably connected to the main unit and the first power supply, and the smart speaker may be configured to be connected to at least one external electronic device and play an audio. The third light illuminator may be connected to the speaker body, and the third light illuminator may be configured to generate a light beam. The base may be connected to the third light illuminator.

One of the beneficial effects of the present disclosure is that, in the modular illumination device provided by the present disclosure, by technical solution of “body unit having a main frame portion, a first light-transmitting portion and a second light-transmitting portion, the first light-transmitting portion being disposed on one side of the main frame portion, the second light-transmitting portion being disposed on another side of the main frame portion, the first power supply being arranged in the main frame portion, the plurality of first light emitters being connected to the first power supply, the plurality of first light emitters being disposed on the main frame portion and corresponding to the first light-transmitting portion and the second light-transmitting portion, the first switch being disposed on the main frame portion, the first switch being connected to the first power supply and the plurality of first light illuminators, and the first switch being configured to toggle at least one of the plurality of first light illuminators to project a light beam toward the corresponding first light-transmitting portion or the corresponding second light-transmitting portion”, the convenience of illumination may be enhanced.

To further understand the features and technical contents of the present invention, please refer to the following detailed description and drawings of the present disclosure. However, the drawings provided are only used for reference and description and are not used to limit the present disclosure.

### BRIEF DESCRIPTION OF THE DRAWINGS

FIG. 1 is a first structural schematic diagram of a modular illumination device according to a first embodiment of the present disclosure.

FIG. 2 is a first perspective diagram showing one of operational states of the modular illumination device according to the first embodiment of the present disclosure.

FIG. 3 is a second perspective diagram showing one of operational states of the modular illumination device according to the first embodiment of the present disclosure.

FIG. 4 is a second structural schematic diagram of the modular illumination device according to the first embodiment of the present disclosure.

FIG. 5 is a perspective diagram showing another operational state of the modular illumination device according to the first embodiment of the present disclosure.

FIG. 6 is a functional block diagram of the modular illumination device according to the first embodiment of the present disclosure.

FIG. 7 is a schematic diagram showing an operational state of the modular illumination device according to the second embodiment of the present disclosure.

FIG. 8 is an exploded schematic diagram of the modular illumination device according to the second embodiment of the present disclosure.

FIG. 9 is a schematic diagram showing an operational state of the modular illumination device according to the third embodiment of the present disclosure.

FIG. 10 is a perspective schematic diagram of the modular illumination device according to the fourth embodiment of the present disclosure.

FIG. 11 is a partial exploded schematic diagram showing one implementation of the modular illumination device according to the fifth embodiment of the present disclosure.

FIG. 12 is a partial exploded schematic diagram showing another implementation of the modular illumination device according to the fifth embodiment of the present disclosure.

FIG. 13 is a partial exploded schematic diagram of the modular illumination device according to the sixth embodiment of the present disclosure.

### DETAILED DESCRIPTION OF THE PREFERRED EMBODIMENTS

The following is a description of the embodiments of the present disclosure related to the “modular illumination device” through specific examples. Those skilled in the art can understand the advantages and effects of the present disclosure from the content disclosed in this specification. The present disclosure may be implemented or applied through other different specific embodiments, and the details in this specification may be modified or changed from different perspectives and applications, without departing from the inventive concept of the present disclosure. Additionally, the accompanying drawings of the present disclosure are for illustrative purposes only and are not drawn to scale, as expressly stated. The following embodiments will provide a more detailed explanation of the related technical content of the present disclosure, but the disclosed content is not intended to limit the scope of protection of the present disclosure.

### First Embodiment

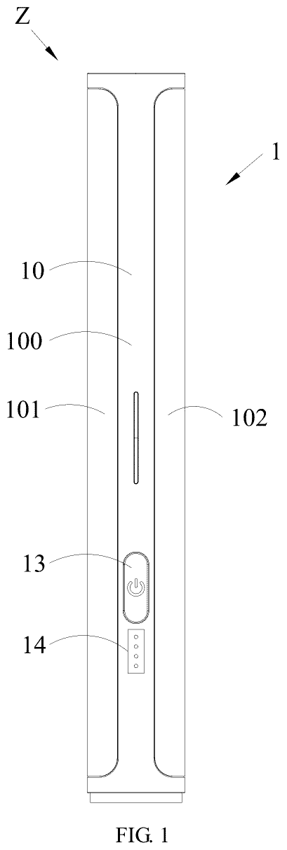

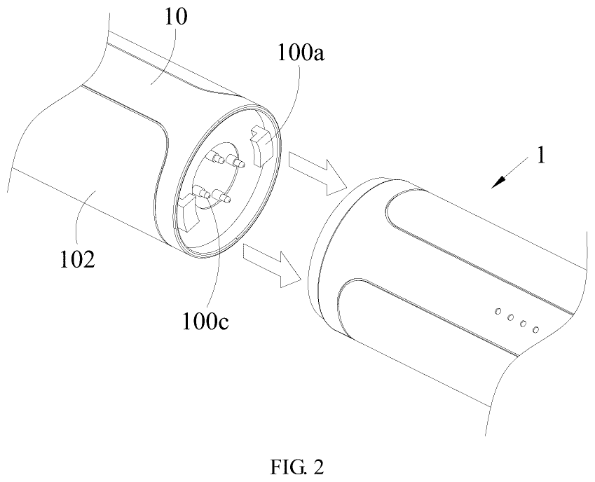

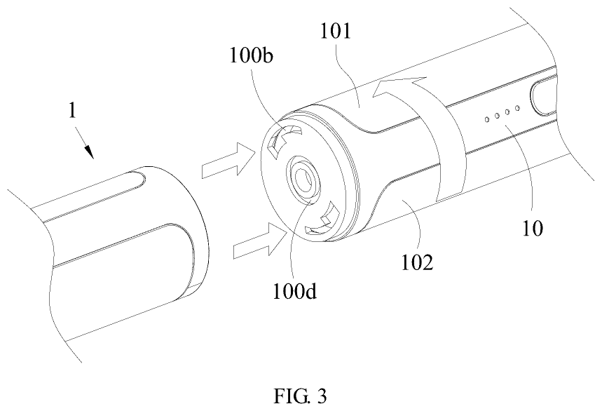

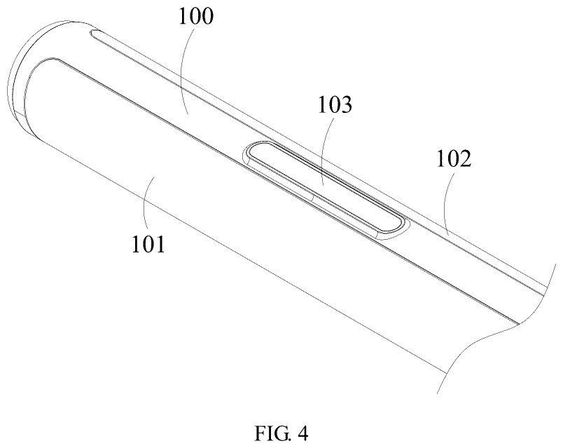

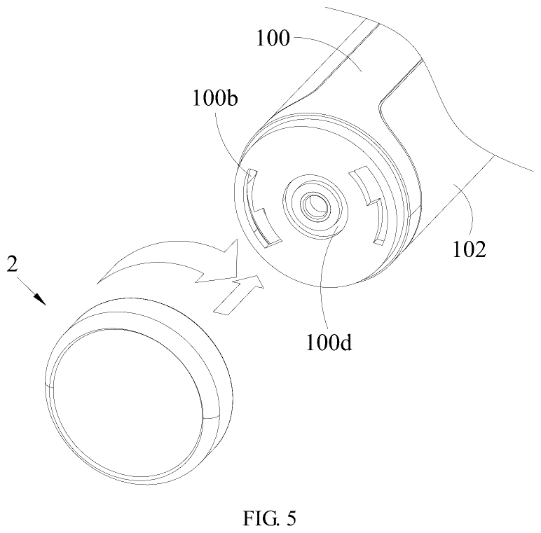

Referring to FIGS. 1 to 6, FIGS. 1 to 6 are respectively a first structural schematic diagram, a first perspective diagram showing one operational state, a second perspective diagram showing one operational state, a second structural schematic diagram, a perspective diagram showing a further operational state, and a functional block diagram of the modular illumination device according to the first embodiment of the present disclosure. As shown in FIGS. 1 to 6, the first embodiment of the present disclosure provides a modular illumination device Z, which may be applied to a mobile vehicle such as an automobile (e.g., pickup truck or van) or a motorcycle. It is preferably applied in the vehicle compartment (or cargo compartment) of the mobile vehicle, but the present disclosure is not limited thereto. The modular illumination device Z may have a substantially cylindrical structure, and in this embodiment, it is exemplified as a substantially cylindrical shape, but the present disclosure is not limited thereto. The modular illumination device Z may include at least one light-emitting module 1, which may include a body unit 10, a first power supply 11, a plurality of first light illuminators 12, and a first switch 13.

With reference to FIGS. 1 to 5, the body unit 10 may include a main frame portion 100, a first light-transmitting portion 101, and a second light-transmitting portion 102. The first light-transmitting portion 101 is positioned on one side of the main frame portion 100, while the second light-transmitting portion 102 is positioned on another side of the main frame portion 100. For example, the main frame portion 100 may be constructed from plastic or metal material as the primary structural component of the modular illumination device Z. The first light-transmitting portion 101 and the second light-transmitting portion 102 may be structured as fully-transmissive or semi-transmissive housings, respectively positioned on two sides of the main frame portion 100. Additionally, the body unit 10 may further include a magnetic attachment portion 103, which may be a magnet or other magnetic components. The magnetic attachment portion 103 may be located on the main frame portion 100 and configured to attract and secure the body unit 10 to an object (such as the vehicle compartment of a vehicle, but the present disclosure is not limited thereto).

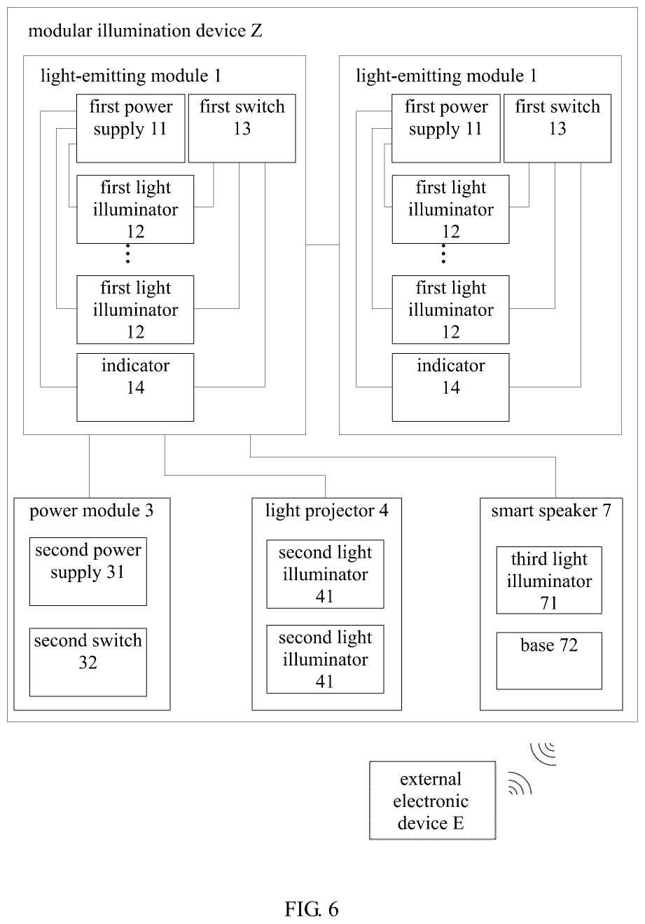

Next, with reference to FIGS. 1 and 6, the first power supply 11 is disposed in the main frame portion 100. For example, the first power supply 11 may be a rechargeable battery component, positioned within an interior of the main frame portion 100.

Subsequently, with reference to FIGS. 1 and 6, the plurality of first light illuminators 12 are connected to the first power supply 11. These first light illuminators 12 are arranged in the main frame portion 100 and correspond to the first light-transmitting portion 101 and the second light-transmitting portion 102. For example, the first light illuminator 12 may be a light-emitting diode (LED), a light tube, or another type of light-emitting component. The plurality of first light illuminators 12 are arranged within the main frame portion 100, with a portion of the first light illuminators 12 positioned between the main frame portion 100 and the first light-transmitting portion 101 and therefore corresponding to the first light-transmitting portion 101, while another portion of the first light illuminators 12 are positioned between the main frame portion 100 and the second light-transmitting portion 102 and therefore corresponding to the second light-transmitting portion 102.

Next, with reference to FIGS. 1 to 6, a first switch 13 is disposed on the main frame portion 100. The first switch 13 is connected to the first power supply 11 and the plurality of first light illuminators 12. The first switch 13 may be configured to toggle at least one of the first light illuminators 12 to project a light beam L toward the corresponding first light-transmitting portion 101 or the corresponding second light-transmitting portion 102. For example, the first switch 13 may be a physical or virtual switch component, and may be installed on the main frame portion 100. The first switch 13 may be configured to toggle the at least one light-emitting module 1 to change from an initial state to a first illumination state, a second illumination state, or a third illumination state. When the at least one light-emitting module 1 is in the first illumination state, at least one of the first light illuminators 12 projects a light beam L toward the corresponding first light-transmitting portion 101. When the at least one light-emitting module 1 is in the second illumination state, at least one of the first light illuminators 12 projects a light beam L toward the corresponding second light-transmitting portion 102. When the at least one light-emitting module 1 is in the third illumination state, the plurality of first light illuminators 12 project multiple light beams L toward both the corresponding first light-transmitting portion 101 and the corresponding second light-transmitting portion 102.

Therefore, with reference to FIGS. 1 to 6, when a user manipulates the modular illumination device Z of the present disclosure, the modular illumination device Z may be positioned in the trunk or the cargo compartment of the mobile vehicle (e.g., an automobile or motorcycle). The user may secure the modular illumination device Z to the wall of the vehicle compartment using a fixing mechanism on the wall (e.g., a clamp, but the present disclosure is not limited thereto), or alternatively, use the magnetic attachment portion 103 to magnetically attach the modular illumination device Z to the wall of the vehicle compartment. Next, the user may activate the first light illuminator 12 by touching or pressing the first switch 13, causing the first light illuminator 12 to emit light, illuminating the interior of the vehicle compartment.

When the user needs to find items in the vehicle under poor illuminating conditions, the user may detach the light-emitting module 1 from the vehicle compartment wall, and then reinstall or magnetically attach the light-emitting module 1 to an appropriate location inside the vehicle, providing the light source needed for item retrieval.

Further, in the initial state, the light-emitting module 1 is in a non-light-emitting state. Next, when the user presses the first switch 13, the light-emitting module 1 may be changed from the initial state to the first illumination state. At this point, the portion of the first light illuminators 12 corresponding to the first light-transmitting portion 101 may project light beams toward the first light-transmitting portion 101, causing the light-emitting module 1 to emit light partially. Then, if the user presses the first switch 13 again, the light-emitting module 1 may be changed from the first illumination state to the second illumination state. At this point, the portion of the first light illuminators 12 corresponding to the second light-transmitting portion 102 may project light beams toward the second light-transmitting portion 102, while the portion of the first light illuminators 12 corresponding to the first light-transmitting portion 101 stops emitting light, causing the light-emitting module 1 to emit light partially.

Next, if the user presses the first switch 13 once more, the light-emitting module 1 may be changed from the second illumination state to the third illumination state. At this point, the portion of the first light illuminators 12 corresponding to the first light-transmitting portion 101 may project light beams toward the first light-transmitting portion 101, while the portion of the first light illuminators 12 corresponding to the second light-transmitting portion 102 may simultaneously project light beams toward the second light-transmitting portion 102, causing the entire light-emitting module 1 to emit light.

It is worth mentioning that the above-described illumination states of the light-emitting module 1 in the present disclosure are provided for illustration purposes and are not limited to the aforementioned description. In actual implementations, the first illumination state may also involve the entire light-emitting module 1 emitting light, while the second and third illumination states may involve partial emission of light from the light-emitting module 1.

Thus, the modular illumination device Z of the present disclosure may, through the aforementioned technical solutions, provide a detachable and magnetically attachable body unit 10, allowing the user to move and install the modular illumination device Z to an appropriate position within the vehicle or any desired positions with corresponding fixing or attaching mechanisms. Furthermore, with the modular illumination device Z offering multiple illumination modes, it may provide the appropriate light source needed by the user.

Furthermore, the modular illumination device Z of the present disclosure may also include a plurality of light-emitting modules 1. One end of the main frame portion 100 of each light-emitting module 1 may have a first connecting portion 100a, while another end of the main frame portion 100 of each light-emitting module 1 may have a second connecting portion 100b. One of the light-emitting modules 1 may be detachably connected to the second connecting portion 100b of another one of the light-emitting modules 1 through the first connecting portion 100a to be connected to the another one of the light-emitting modules 1.

For example, with reference to FIGS. 1 to 5, an end surface of one end of the body unit 10 of each light-emitting module 1 may protrude outward to form a plurality of hook structures, constituting the first connecting portion 100a. Additionally, an end surface of another end of the body unit 10 of each light-emitting module 1 may be recessed inward to form a plurality of groove structures, constituting the second connecting portion 100b. Therefore, when a large area of illumination is required, such as the entire vehicle interior or the long trunk of a pickup truck, the user may adopt a splicing method, connecting multiple light-emitting modules 1 together. The user may then install or magnetically attach the connected modules to the vehicle interior, such that a large area inside the vehicle is illuminated by the combined light-emitting modules 1. Additionally, the body unit 10 of each of the light-emitting modules 1 of the present disclosure may further include a plurality of first terminal portions 100c and a second terminal portion 100d. The first terminal portion 100c may be an elongated structure, while the second terminal portion 100d may be a flat-plate structure. A plurality pairs of the first terminal portion 100c and the second terminal portion 100d may be provided. One pair of the first terminal portion 100c and the second terminal portion 100d may be configured to be a positive terminal for the transmission of the positive DC power, and the other pair of the first terminal portion 100c and the second terminal portion 100d may be configured to be a negative terminal for the transmission of the negative DC power, but the present disclosure is not limited thereto. The plurality of first terminal portions 100c and the second terminal portion 100d are electrically connected to the first power supply 11 and/or the first switch 13. The plurality pairs of the first terminal portion 100c and the second terminal portion 100d may be configured to transmit not only the power signals to or from the first power supplies 11 between two coupled light-emitting modules 1, but also the control signals for toggling illumination modes to or from the first switches 13 between two coupled light-emitting modules 1. Therefore, when the light-emitting modules 1 are connected to one another, one of the light-emitting modules 1 may contact the second terminal portion 100d of another one of the light-emitting modules 1 via the plurality of first terminal portions 100c, establishing an electrical connection between the two light-emitting modules 1. That is, the first power supply 11 of the one of the light-emitting modules 1 may be electrically connected to the first power supply 11 of the another one of the light-emitting modules 1, and the first switch 13 of the one of the light-emitting modules 1 may control the plurality of first light illuminators 12 of the another one of the light-emitting modules 1, but the present disclosure is not limited thereto.

Furthermore, the at least one light-emitting module 1 may also include an indicator 14, which may be connected to the first power supply 11. The indicator 14 is configured to display a power status of the first power supply 11.

For example, with reference to FIGS. 1 to 6, the body unit 10 of the light-emitting module 1 of the present disclosure may further include an indicator 14, which may include a physical structure (e.g., multiple light-emitting elements) or a virtual structure (e.g., a display panel). The indicator 14 may detect and display the current power status of the first power supply 11.

In other preferred embodiments, the indicator 14 may also be connected to the first switch 13 and the first power supply 11, such that a controller or certain logic circuits, which are well-known in the art, within the indicator 14 may detect the current power status of the first power supply 11 and controls the indicator 14 to show the current power status of the first power supply 11.

Furthermore, the modular illumination device Z may also include at least one covering module 2, which may be detachably connected to the main frame portion 100 of one of the light-emitting modules 1. The at least one covering module 2 may be configured to cover the first connecting portion 100a or the second connecting portion 100b, as well as to be magnetically attached to an object.

For example, with reference to FIGS. 1 to 5, the covering module 2 of the present disclosure may have a disc-shaped structure, but the present disclosure is not limited thereto. A portion of the covering module 2 may be made of magnetic material, and one side of the covering module 2 may also be provided with a connecting structure identical or similar to the first connecting portion 100a or the second connecting portion 100b, and the description of the first connecting portion 100a or the second connecting portion 100b may also be applied to such connecting structure and will not be repeated herein. Therefore, the user may detachably connect the at least one covering module 2 to one end of the body unit 10 of the light-emitting module 1, which may not only prevent foreign objects or moisture from entering the body unit 10 through the first connecting portion 100a or the second connecting portion 100b, but may also provide an aesthetic effect. Additionally, the covering module 2 may be magnetically attached to the vehicle interior, thereby securing the light-emitting module 1 in place.

However, the above examples are merely one of the possible embodiments and are not intended to limit the scope of the present disclosure.

### Second Embodiment

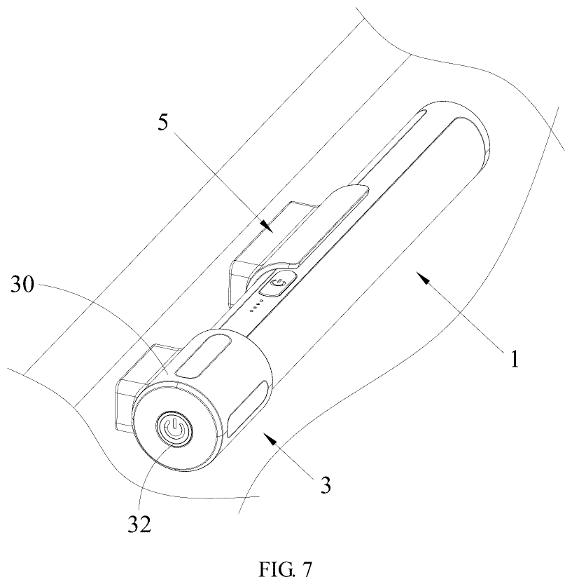

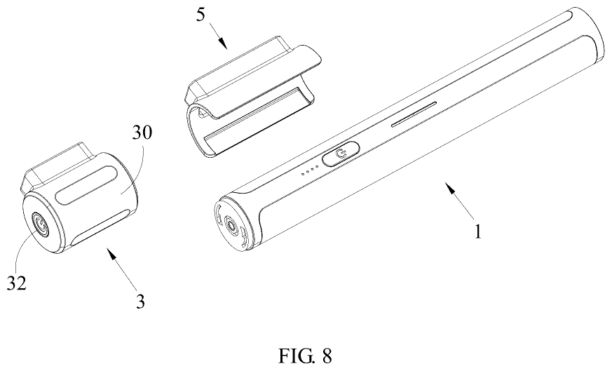

Referring to FIGS. 7 and 8, FIGS. 7 and 8 are a schematic diagram showing an operational state of the modular illumination device and an exploded schematic diagram of the modular illumination device according to the second embodiment of the present disclosure. Reference is also made to FIGS. 1 to 6. As shown in the figures, the modular illumination device Z in this embodiment is substantially similar to the modular illumination device Z of the previous embodiment, and thus, the arrangement or operation of the same components will not be repeated herein. The difference between the second embodiment and the first embodiment is that, in this embodiment, the modular illumination device Z may further include a power module 3, which may include a main unit 30, a second power supply 31, and a second switch 32. The second power supply 31 is disposed in the main unit 30. The second switch 32 is disposed in the main unit 30. When the main unit 30 is connected to the body unit 10, the second power supply 31 is electrically connected to the first power supply 11. The second switch 32 may be configured to toggle at least one of the first light illuminators 12 to project a light beam L toward the corresponding first light-transmitting portion 101 or the corresponding second light-transmitting portion 102.

For example, with reference to FIGS. 6 to 8, the main unit 30 may have a substantially cylindrical structure, but it is not limited thereto. The shape of the main unit 30 may match with the shape of the body unit 10 of the light-emitting module 1. One end of the main unit 30 may be provided with the second switch 32, and another end of the main unit 30 may be provided with a connecting structure similar to the first connecting portion 100a or the second connecting portion 100b and terminal portions similar to the plurality of first terminal portions 100c and second terminal portions 100d may be included. The description of the first connecting portion 100a or the second connecting portion 100b may also be applied to such connecting structure on the main unit 30, and the description of first terminal portions 100c and second terminal portions 100d may also be applied to such terminal portions on the main unit 30, and therefore will not be repeated herein. The second power supply 31 may be a rechargeable battery component, disposed inside the main unit 30.

Therefore, when the power of the light-emitting module 1 is running low or insufficient, the user may connect the main unit 30 of the power module 3 to the body unit 10 of the light-emitting module 1, such that the second power supply 31 of the power module 3 may be electrically connected to the first power supply 11 of the light-emitting module 1, and the second power supply 31 may provide power to charge the first power supply 11. Additionally, the user may press the second switch 32 to control the light-emitting module 1 to manipulate in at least one of the first light-emitting state, the second light-emitting state, and the third light-emitting state. In addition, one other difference between this embodiment and the previous embodiments is that, in this embodiment, the modular illumination device Z may further include a bracket module 5, as will be described shortly in the Fourth Embodiment.

However, the above examples are merely one of the possible embodiments and are not intended to limit the scope of the present disclosure.

### Third Embodiment

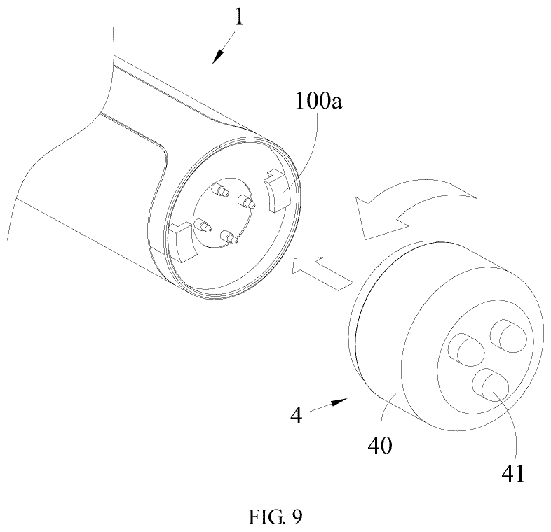

Referring to FIG. 9, FIG. 9 is a schematic diagram showing an operational state of the modular illumination device according to the third embodiment of the present disclosure. Reference is also made to FIGS. 1 to 8. As shown in the figures, the modular illumination device Z of this embodiment is substantially similar to the modular illumination device Z of the previous embodiments, and therefore, the arrangement or operation of the same components will not be repeated here. The difference between this embodiment and the previous embodiments is that, in this embodiment, the modular illumination device Z may further include a light projector 4, which may include a head unit 40 and a plurality of second light illuminators 41. The plurality of second light illuminators 41 are disposed in the head unit 40. When the head unit 40 is connected to the body unit 10, the plurality of second light illuminators 41 are connected to the first power supply. The first switch 13 is configured to toggle the plurality of second light illuminators 41 to project light beams L.

For example, as shown in FIGS. 6 and 9, the head unit 40 may have a disc-like structure, but it is not limited thereto; part of the structure of the head unit 40 may be made of a transparent material. The second light illuminators 41 may be light-emitting diodes (LEDs) or other types of light-emitting components, and are disposed inside the head unit 40. One end of the head unit 40 may be provided with a connecting structure similar to the first connecting portion 100a or the second connecting portion 100b and terminal portions similar to the plurality of first terminal portions 100c and second terminal portions 100d. The description of the first connecting portion 100a or the second connecting portion 100b may also be applied to such connecting structure on the head unit 40, and the description of first terminal portions 100c and second terminal portions 100d may also be applied to such terminal portions on the head unit 40, and therefore will not be repeated herein. Therefore, the user may connect the head unit 40 of the light projector 4 to one end of the body unit 10 of the light-emitting module 1, such that the first power supply 11 of the light-emitting module 1 is electrically connected to the plurality of second light illuminators 41, allowing the plurality of second light illuminators 41 to project light beams, thus enabling the modular illumination device Z to function as a flashlight.

It is worth mentioning that the second light illuminators 41 may be in an illuminated state after the light projector 4 is connected to the light-emitting module 1, or the second light illuminators 41 may also be controlled to illuminate by the user triggering the first switch 13 after the light projector 4 is connected to the light-emitting module 1.

However, the above examples are merely one of the possible embodiments and are not intended to limit the scope of the present disclosure.

### Fourth Embodiment

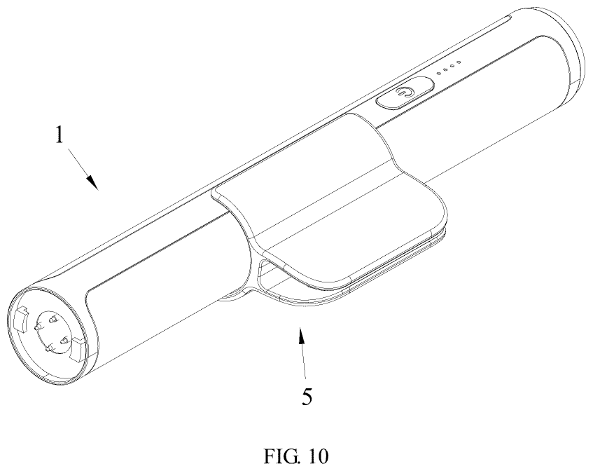

Referring to FIG. 10, FIG. 10 is a perspective schematic diagram of the modular illumination device according to the fourth embodiment of the present disclosure. Reference is also made to FIGS. 1 to 9. As shown in the figures, the modular illumination device Z in this embodiment is substantially similar to the modular illumination device Z of the previous embodiments, and thus, the arrangement or operation of the same components will not be repeated here. The difference between this embodiment and the previous embodiments is that, in this embodiment, the modular illumination device Z may further include a bracket module 5, which may be detachably connected to the body unit 10. The bracket module 5 is configured to be detachably connected to an object.

For example, as shown in FIGS. 1 to 8 and 10, the bracket module 5 may be a magnetic structure (as shown in FIGS. 7 and 8) or a clamping structure (as shown in FIG. 10). One side of the bracket module 5 may be detachably connected to the body unit 10 of the light-emitting module 1, while another side of the bracket module 5 may be detachably connected to an object (such as the wall of the vehicle compartment or a seat inside the vehicle, but not limited to these examples). Therefore, the user may use the bracket module 5 in combination with the light-emitting module 1, allowing the light-emitting module 1 to be freely fixed in any suitable position inside the vehicle. Alternatively, when the modular illumination device Z is applied for uses in addition to vehicles, the light-emitting module 1 may be freely fixed to any suitable object (such as a computer monitor or a table, but not limited to these examples).

However, the above examples are merely one of the possible embodiments and are not intended to limit the scope of the present disclosure.

### Fifth Embodiment

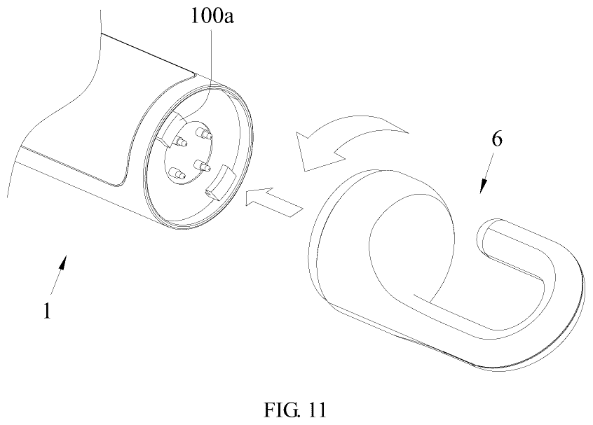

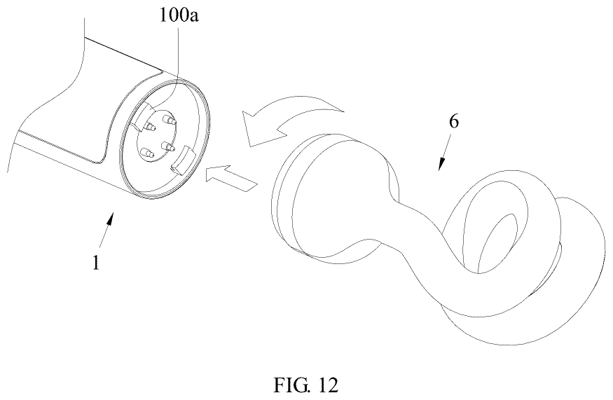

Referring to FIGS. 11 and 12, FIG. 11 is a partial exploded schematic diagram showing one implementation of the modular illumination device according to the fifth embodiment of the present disclosure, and FIG. 12 is a partial exploded schematic diagram showing another implementation of the modular illumination device according to the fifth embodiment of the present disclosure. Reference is also made to FIGS. 1 to 10. As shown in the figures, the modular illumination device Z in this embodiment is substantially similar to the modular illumination device Z of the previous embodiments, and thus, the arrangement or operation of the same components will not be repeated here. The difference between this embodiment and the previous embodiments is that, in this embodiment, the modular illumination device Z may further include a hook module 6, which may be detachably connected to the body unit 10. The hook module 6 is configured to be detachably connected to an object.

For example, with reference to FIGS. 1 to 5, 11, and 12, one end of the hook module 6 may be provided with a connecting structure similar to the first connecting portion 100a or second connecting portion 100b, while another end of the hook module 6 may be provided with a U-shaped hook structure (as shown in FIG. 11) or a spiral hook structure (as shown in FIG. 12). The description of the first connecting portion 100a or the second connecting portion 100b may also be applied to such connecting structure on the hook module 6, and therefore will not be repeated herein. Therefore, the user may connect one end of the hook module 6 to one end of the body unit 10 of the light-emitting module 1, and use another end of the hook module 6 to detachably hook onto an object (such as the wall of the vehicle compartment or a seat inside the vehicle, but not limited to these examples). This allows the modular illumination device Z to be freely fixed in any suitable position inside the vehicle. Furthermore, when the modular illumination device Z is applied for uses in addition to vehicles, it may also be freely fixed to any suitable object (such as the securing rope of a tent, but not limited to this example).

However, the above examples are merely one of the possible embodiments and are not intended to limit the scope of the present disclosure.

### Sixth Embodiment

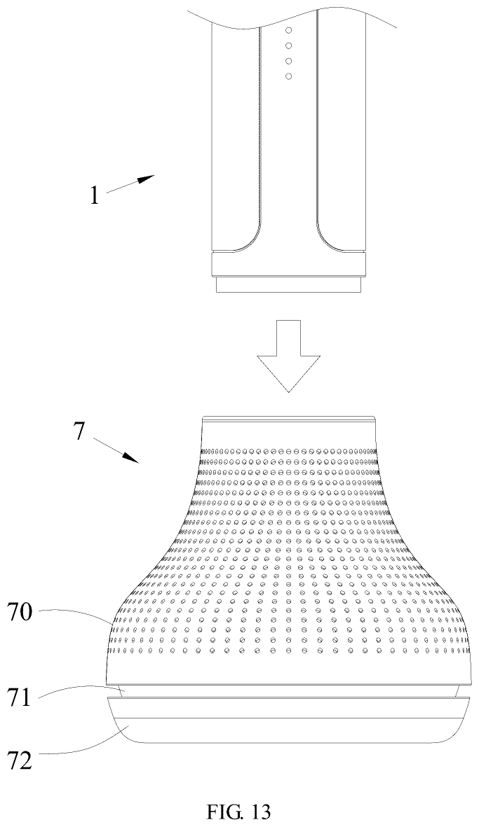

Referring to FIG. 13, FIG. 13 is a partial exploded schematic diagram of the modular illumination device according to the sixth embodiment of the present disclosure. Reference is also made to FIGS. 1 to 12. As shown in the figures, the modular illumination device Z in this embodiment is substantially similar to the modular illumination device Z of the previous embodiments, and thus, the arrangement or operation of the same components will not be repeated here. The difference between this embodiment and the previous embodiments is that, in this embodiment, the modular illumination device Z may further include a smart speaker 7, which may include a speaker body 70, a third light illuminator 71, and a base 72. The speaker body 70 may be detachably connected to the body unit 10 and the first power supply 11. The smart speaker 7 may be configured to connect with at least one external electronic device E and play audio. The third light illuminator 71 may be connected to the speaker body 70 and configured to generate a light beam L. The base 72 may be configured to support the speaker body 70 and the third light illuminator 71.

For example, with reference to FIGS. 1 to 5 and 13, the speaker body 70 may include a wireless speaker module, such as a Bluetooth speaker, but is not limited thereto. The third light illuminator 71 may be a light-emitting component. The base 72 may be a disc-shaped base structure, but is not limited thereto. One end of the speaker body 70 may have a connecting structure similar to the first connecting portion 100a or second connecting portion 100b and terminal portions similar to the first terminal portions 100c and the second terminal portion 100d. The description of the first connecting portion 100a or the second connecting portion 100b may also be applied to such connecting structure on the speaker body 70, and the description of first terminal portions 100c and second terminal portions 100d may also be applied to such terminal portions on the speaker body 70, and therefore will not be repeated herein. Another end of the speaker body 70 is connected to the third light illuminator 71. Therefore, the user may detachably connect the speaker body 70 to one end of the body unit 10 of the light-emitting module 1 and use the smart speaker 7 to secure the light-emitting module 1. Then, when the user places the modular illumination device Z in any suitable position inside or outside the vehicle, the base 72 may be used to support the speaker body 70, the third light illuminator 71, and the light-emitting module 1. The light-emitting module 1 may provide the user with the required light source. In one embodiment, the third light illuminator 71 may also be coupled to the first power supply 11 and the first switch 13 via the plurality pairs of the first terminal portion 100c and the second terminal portion 100d between the speaker body 70 and the connected body unit 10, the third light illuminator 71 may then supplied power from the power supply 11 and toggled to project light by the first switch 13. The smart speaker 7 may be in communication with the user's electronic products (i.e., external electronic device E, such as a smartphone or tablet, but not limited thereto) to play music via the speaker body 70.

It is worth mentioning that the speaker body 70 may be provided with a built-in battery component, or may be powered by the first power supply 11 of the light-emitting module 1.

However, the above examples are merely one of the possible embodiments and are not intended to limit the scope of the present disclosure.

### Beneficial Effects of Embodiments

One of the beneficial effects of the present disclosure is that, in the modular illumination device Z provided by the present disclosure, by technical solution of “body unit 10 having a main frame portion 100, a first light-transmitting portion 101 and a second light-transmitting portion 102, the first light-transmitting portion 101 being disposed on one side of the main frame portion 100, the second light-transmitting portion being disposed on another side of the main frame portion 100, the first power supply 11 being arranged in the main frame portion 100, the plurality of first light emitters 12 being connected to the first power supply 11, the plurality of first light emitters 12 being disposed on the main frame portion 100 and corresponding to the first light-transmitting portion 101 and the second light-transmitting portion 102, the first switch 13 being disposed on the main frame portion 100, the first switch 13 being connected to the first power supply 11 and the plurality of first light illuminators 12, and the first switch 13 being configured to toggle at least one of the plurality of first light illuminators 12 to project a light beam L toward the corresponding first light-transmitting portion 101 or the corresponding second light-transmitting portion 102”, the convenience of illumination may be enhanced.

Furthermore, the modular illumination device Z of the present disclosure may, through the aforementioned technical solution, utilize the detachable and adhesive body unit 10, allowing users to move and install the modular illumination device Z to an appropriate position within the vehicle or any desired location with corresponding fixing or attaching mechanisms. Additionally, with the modular illumination device Z offering multiple illumination modes, it may provide the user with the appropriate light source as needed.

Moreover, practicality and versatility may be increased by the modular illumination device Z of the present disclosure by combining at least one of the light-emitting module 1 with the covering module 2, power module 3, light projector 4, bracket module 5, hook module 6, and smart speaker 7.

The above disclosed contents are only the preferred feasible embodiments of the present invention, and do not limit the scope of the patent application of the present invention. Therefore, all equivalent technical changes made by using the contents of the description and drawings of the present invention are included in the scope of the patent application of the present invention.

What is claimed is:

1. A modular illumination device, comprising:
at least one light emitting module, including:
a body unit having a main frame portion, a first light-transmitting portion and a second light-transmitting portion, wherein the first light-transmitting portion is disposed on one side of the main frame portion, and the second light-transmitting portion is disposed on another side of the main frame portion;
a first power supply disposed in the main frame portion;
a plurality of first light emitters connected to the first power supply, wherein the plurality of first light emitters are disposed on the main frame portion and correspond to the first light-transmitting portion and the second light-transmitting portion; and
a first switch disposed on the main frame portion, wherein the first switch is connected to the first power supply and the plurality of first light illuminators, and the first switch is configured to toggle at least one of the plurality of first light illuminators to project a light beam toward the corresponding first light-transmitting portion or the corresponding second light-transmitting portion.

2. The modular illumination device according to claim 1, wherein the first switch is configured to toggle the at least one light-emitting module to change from an initial state to a first light-emitting state, a second light-emitting state or a third light-emitting state;
wherein, when the at least one light-emitting module is in the first light-emitting state, at least one of the first light illuminators projects the light beam toward the corresponding first light-transmitting portion;
wherein, when the at least one light-emitting module is in the second light-emitting state, at least one of the first light illuminators projects the light beam toward the corresponding second light-transmitting portion;
wherein, when the at least one light emitting module is in the third light emitting state, the plurality of first light emitters project a plurality of light beams toward the corresponding first light-transmitting portion and the second light-transmitting portion.

3. The modular illumination device according to claim 1, further comprising multiple ones of the light-emitting module, wherein one end the main frame portion of each of the light-emitting modules has a first connecting portion, another end the main frame portion of each of the light-emitting modules has a second connecting portion, one of the light-emitting modules is detachably connected to the second connecting portion of another one of the light-emitting modules through the first connecting portion, so as to be connected to the another one of the light-emitting modules.

4. The modular illumination device according to claim 3, wherein an end surface of the one end of the main frame portion protrudes outward to form a plurality of hook structures to form the first connecting portion, and an end surface of the another end of the main frame portion is recessed inward to form a plurality of groove structures to form the second connecting portion;
wherein the modular illumination device further comprises at least one covering module detachably connected to the main frame portion of one of the light-emitting modules, and the at least one covering module is configured to cover the first connecting portion or the second connecting portion and to be attached on an object.

5. The modular illumination device according to claim 1, wherein the main unit further includes a magnetic attachment portion located on the main frame portion, and the magnetic attachment portion is configured to magnetically coupled to an object;
wherein the at least one light emitting module further includes an indicator connected to the first power supply, and the indicator is configured to display a power status of the first power supply.

6. The modular illumination device according to claim 1, further comprising a power module, including:
a main unit;
a second power supply disposed in the main unit; and
a second switch disposed in the main unit;
wherein, when the main unit is connected to the body unit, the second power supply is connected to the first power supply;
wherein, the second switch is configured to toggle at least one of the first light illuminators to project a light beam toward the corresponding first light-transmitting portion or the corresponding second light-transmitting portion.

7. The modular illumination device according to claim 1, further comprising a light projector, including:
a head unit; and
a plurality of second light illuminators disposed in the head unit;
wherein, when the light projector is connected to the body unit, the plurality of second light illuminators are connected to the first power supply;
wherein the first switch is configured to toggle the plurality of second light illuminators to project light beams.

8. The modular illumination device according to claim 1, further comprising a bracket module detachably connected to the body unit, and the bracket module is configured to be detachably connected to an object.

9. The modular illumination device according to claim 1, further comprising a hook module detachably connected to the body unit, and the hook module is configured to be detachably connected to an object.

10. The modular illumination device according to claim 1, further comprising a smart speaker, including:
a speaker body detachably connected to the main unit and the first power supply, and the smart speaker is configured to be in communication with at least one external electronic device and play an audio;
a third light illuminator connected to the speaker body, wherein the third light illuminator is configured to generate a light beam; and
a base connected to the third light illuminator.
